(19) United States
(12) Patent Application Publication
(10) Pub. No.: US 2004/0195283 A1
(43) Pub. Date: Oct. 7, 2004

(54) Infant or child car seat carrying device

(76) Inventor: Lori Ann Zebraski, Fredonia, NY (US)

Correspondence Address: KURT LEYENDECKER, 9241 S LARK SPARROW DR., HIGHLANDS RANCH, CO, 80126, US

(21) Appl. No.: 10/404,240

(22) Filed: Apr. 1, 2003

(51) Int. Cl. A45F 3/04; A61G 1/00

(52) U.S. Cl. 224/259; 224/161

(57) ABSTRACT

A car seat carrying device is described that permits a user to carry an empty car seat on his or her back freeing his or her hands and arms to perform other tasks. One embodiment of the device includes left and right shoulder straps connected by a center section. The center section is typically threaded through slotted openings in the car seat. Slotted openings are generally provided in car seats to permit seat belts or LATCH straps to pass through them when securing a car seat in a vehicle.

### FIELD OF THE INVENTION

The invention relates generally to carrying infant/booster car seats and more specifically to a device permitting a person to carry an empty car seat hands free.

### BACKGROUND OF THE INVENTION

Regulations in the United States require that infants and young children must be secured in appropriately designed car seats when being transported by automobile. A child's caregiver when traveling with the child by air must usually bring a car seat with him/her so that the child can be safely transported in an automobile when the travel destination is reached.

To travel by air with an infant or child, a parent or caregiver must transport the infant or child, a care or diaper bag for the infant or child, a car seat, and his/her own luggage from an airport parking lot to the particular airline's check-in counter. Accordingly, air travel with an infant or child is accomplished with great difficulty. Often two caregivers are required to shuttle the infant and all the necessary accoutrements to airline check-in counter. Of course, if a set of parents has two children that each require a car seat, multiple trips between their automobile in the airport parking lot and the airline check-in counter maybe required.

Slings (U.S. Pat. Nos. 6,378,746; 6,378,937; and 5,267,680) that connect to an infant carrier and are placed over a single shoulder of the caregiver so that an infant carrier, typically with an infant contained therein, can be carried resting against one of the caregiver's legs or hip. These slings are configured to help carry an infant carrier by transferring some of the weight of the carrier and the infant through the caregiver's shoulder. The caregiver must typically continue to use his/her hand to stabilize the infant carrier. Even if the no hand is utilized to stabilize the infant carrier, the location of the carrier prevents a caregiver from carrying a suitcase or diaper bag with the hand or arm immediately above the infant seat. Further, these slings are designed for use with infant carriers only.

Infant carriers are designed to be carried by a person and have handles for that purpose. Infant carriers are limited to use with infants that are either under 20 pounds or less than 26 inches in length. Accordingly such carriers, which may often be used as car seats via provided slots or a suitable base unit, are typically used to transport an infant only in the infant's first year. In Contrast, many infant and child car seats, such as those utilized by infants and children over 20 pounds, cannot be easily carried or transported by a person since they are designed only for use in an automobile. The aforementioned slings cannot be easily utilized with these types of child or infant car seats.

### SUMMARY OF THE INVENTION

A device for a user to carry a car seat on his/her back while walking without requiring the use of his/her hands is described. One embodiment of the device includes a first shoulder support, a second shoulder support and a center section. The center section spans between and is connected to each of the shoulder supports. The center section is also adapted to connected with the car seat.

A method of transporting an infant or child car seat by a user is described. First, a car seat carrying device is attached to the car seat. The device includes first and second shoulder supports and is adapted to permit the user to carry the car seat with the car seat being in general contact with his/her back such that a substantial portion of the weight of the car seat is transferred through the shoulder supports to the user's body. Next, the user places the first and second shoulder supports on the user's respective first and second shoulders to situate the car seat in general contact with the user's back. Finally, the user walks with the car seat on his/her back.

A system comprising a car seat carrying device and a car seat is described. The car seat is designed to carry one of a child and an infant when properly configured and attached to a vehicle. The car seat carrying device includes first and second shoulder strap loops, and a center section connected with the first and the second shoulder strap loops. The center section is connected to the car seat. Accordingly, a user can place the first and the second shoulder strap loops on his/her respective left and right shoulders with the car seat being in general contact with his/her back.

### BRIEF DESCRIPTION OF THE DRAWINGS

The following figures are provided by way of example and not limitation. Element numbers that share the last two digits generally represent similar, but not necessarily identical, elements in each of the figures in which they appear.

FIGS. 1 and 2 are views of the car seat carrying device from two different perspectives according to a preferred embodiment of the invention.

FIG. 3 is front view of a person using the car seat carrying device to carry a child car seat on his/her back.

FIG. 4 is a view of the backside of a car seat with the car seat carrying device installed thereon.

FIG. 5 is an isometric view of a person using the car seat carrying device to carry a car seat.

FIG. 6 is a flow chart concerning the use of the car seat carrying device.

FIGS. 7 and 8 are views of alternative embodiment car seat carrying devices from two different perspectives.

### DETAILED DESCRIPTION

### OVERVIEW

A device is described to facilitate the carrying of an infant or child car seat by a caregiver on his/her back. One preferred embodiment of the device comprises two loops adapted to be slung over a user's shoulders, and a center section joining the loops together, wherein the center section is adapted to fit through slotted openings on a child or infant car seat that are designed to receive a seat belt or LATCH strap. As used herein, the term, “car seat” refers to any seat or booster seat that is removable from a vehicle and is used primarily to safety contain children and infants for safe travel in a moving vehicle. It is to be appreciated that a car seat can be utilized in trucks, trains, planes, and other vehicles in addition to cars.

By placing the center section through the car seat slotted openings, a caregiver can carry the car seat on his/her back much in the manner that a back pack would be carried, thereby freeing the both the caregiver's hands to carry luggage, a diaper bag, hold an infant, push a stroller and/or perform other tasks. The instant invention makes it easier for a caregiver to transport a child or infant and the many other items necessary for air travel to and from the airport and an automobile.

In preferred embodiments of the device, the shoulder strap loops can be padded and include buckles permitting the length of the straps to be adjusted to fit caregivers of different sizes. The center section can comprise a flexible fabric strap with an adjustment mechanism for changing the span between the two should strap loops to accommodate different car seats. Further, the center section can include a buckle permitting the two shoulder straps to be separated helping facilitate the threading of the device through the car seat openings.

The embodiments of the infant or child car seat carrying device illustrated in the accompanying Figures and described herein are merely exemplary and are not meant to limit the full scope of the invention. It is to be appreciated that numerous variations to the invention have been contemplated as would be obvious to one of ordinary skill in the art with the benefit of this disclosure. All variations to the invention that read upon the appended claim language are intended and contemplated to be within the scope of the invention.

### A PREFERRED EMBODIMENT

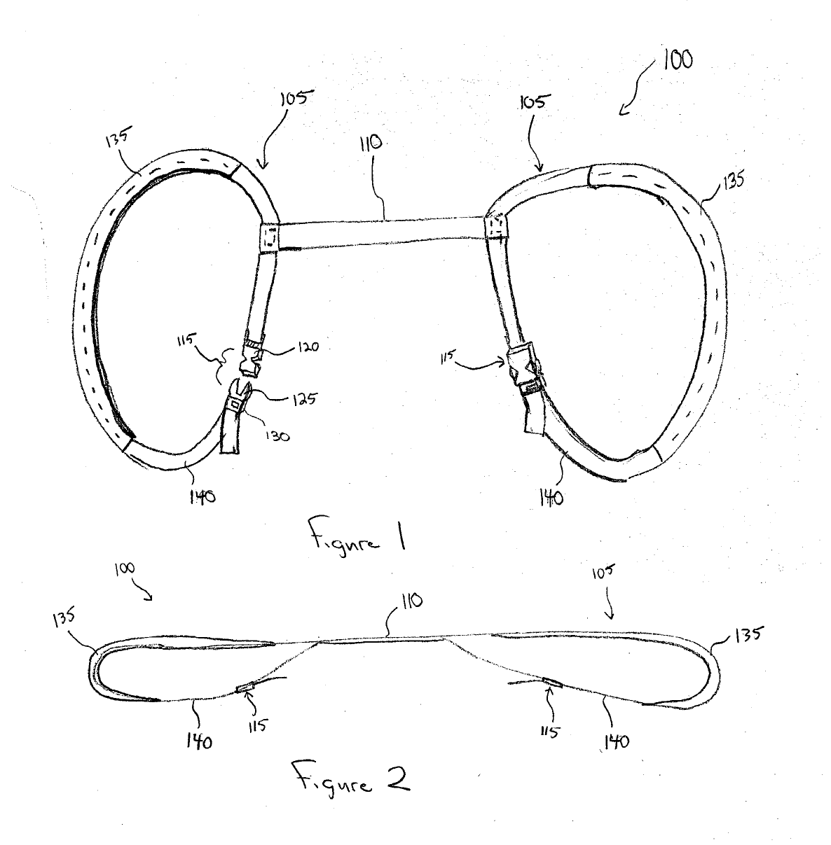

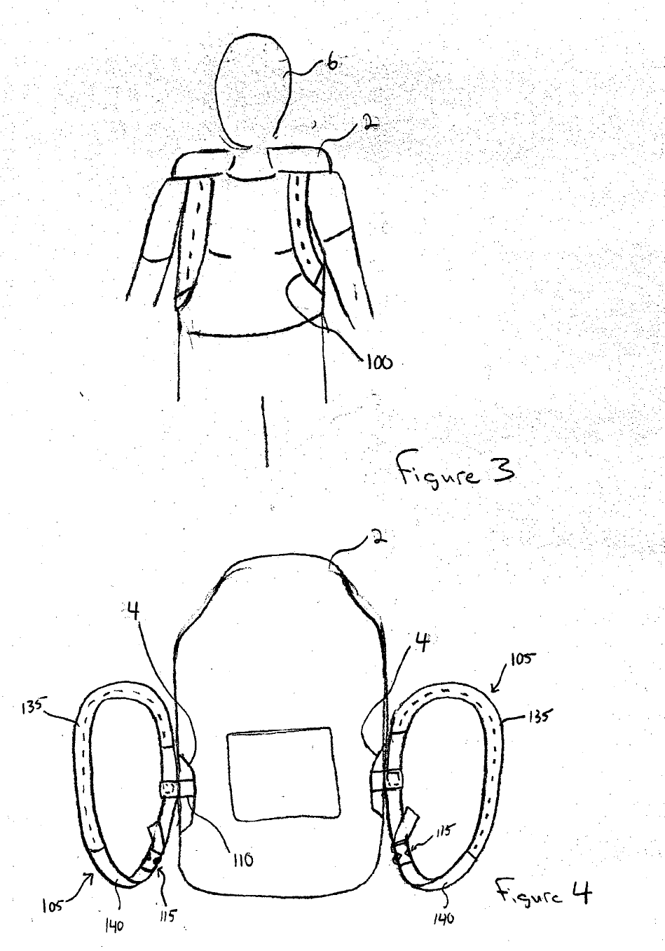

A first preferred embodiment of the car seat carrying device is illustrated in FIGS. 1 and 2. The device 100 comprises left and right shoulder strap loops 105 that are joined together by a center section 110.

Each shoulder strap loop 105 is sized and otherwise adapted to fit over the shoulder of a person. Each loop typically includes a woven strap 140 with a first end that terminates at a female portion 120 of a buckle 115 and a second end that is looped through at a male portion 125 of the buckle such that the male and female portions couple with each other to form the shoulder strap loop. The woven strap is typically comprised of nylon, polypropylene, polyethylene, cotton or any other suitable natural or synthetic fiber. Alternatively, the strap can be comprised of (i) a flexible unitary polymeric material that is not woven, (ii) leather or (iii) a synthetic leather material. A padded section 135 is provided on each shoulder strap to increase the comfort of the user. The buckle 115 of each shoulder strap 105 is typically made of an injection molded polymeric material such as nylon and includes a strap length adjustment mechanism 130 to permit the size of the shoulder strap loop to be varied to fit various users. The male portion 125 typically includes two resilient prongs that are configured to be lockably received into a cavity in the female portion 120. Any number of suitable alternative buckle types of various configurations and designs that are well known in the art can also be utilized. For example, the plastic buckle 115 can be replaced with a double D-ring buckle, or it could be replaced with a single piece plastic or metal buckle that facilities easy loop size adjustments. Further, other means of joining the loops may be utilized including, but not limited to, hook and loop material, and buttons in place of the buckles.

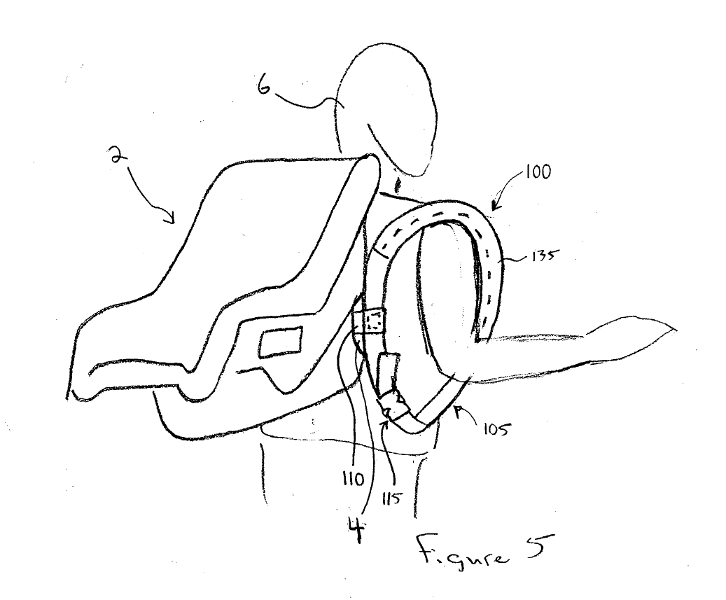

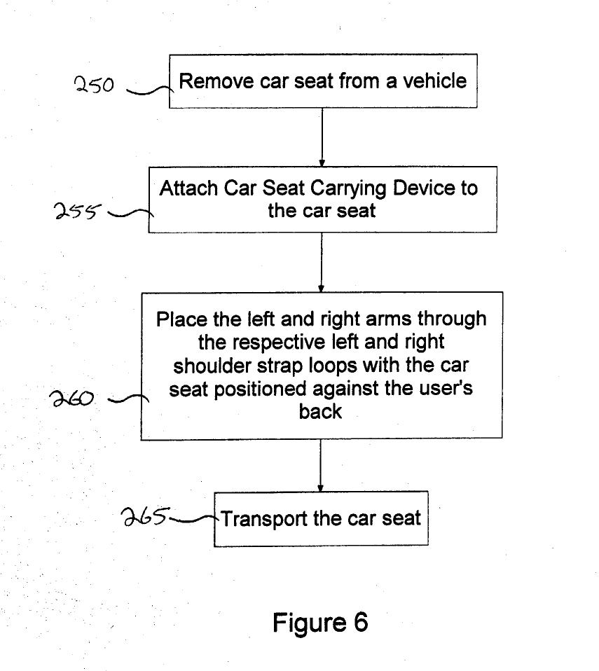

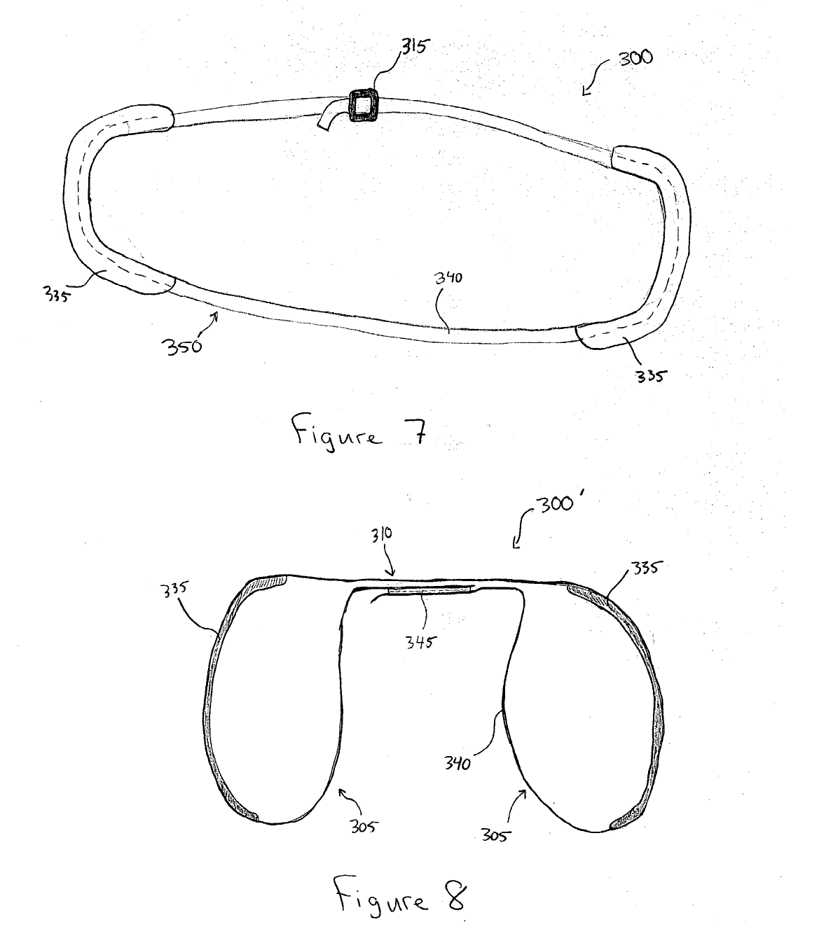

The center section 110 is also typically comprised of a woven strap material that is similar to the shoulder strap loop material. The center section spans between the two shoulder straps 105 with each end of the center section secured to a shoulder strap loop. In the preferred embodiment, the center section has a fixed length that is suitable to span opposing slots 4 provided in the typical car seat 2 (see FIG. 4). The center section can include a buckle and/or a length adjustment mechanism (not shown), so that the length of the center section can be varied for different car seats. Further, by providing a buckle, the center section can be separated into two pieces to permit the device to be installed on a car seat with greater ease. In variations, the center section can be comprised of a solid polymeric material that is either resilient or relatively stiff. Additionally, the center section could be configured to matingly join with specific types of car seats. For example, a center section could include snaps, buttons, or hook and loop material positioned on it to mate with corresponding snaps or hook and loop material on the specifically configured car seat.

### A METHOD OF USING THE CAR SEAT CARRYING DEVICE

A flow chart describing the use of the child car seat carrying device is provided in FIG. 6.

As indicated in block 250, a user removes the car seat from an automobile, plane, train or other vehicle to which it is secured. In block 255, the car seat carrying device 100 is attached to the car seat 2. In reference to the preferred embodiment, the device is slid through slotted openings in the car seat, which are generally provided to receive a seat belt or LATCH strap therethrough, until a shoulder strap loop 105 is positioned on either side of the car seat as best shown in FIG. 4. Next, the user slides a shoulder strap loop through each of his/her arm, placing the car seat against his/her back as shown in block 260. Finally in block 265, the car seat is transported by the user, while the user has free use of both arms and hands to carry luggage, hold the hand of a child, carry a baby, and/or push a stroller.

FIGS. 3 and 5 illustrate a car seat 2 positioned against the back of a user 6 through the use of the car seat carrying device 100.

### ALTERNATIVE EMBODIMENTS

A number of alternative embodiments of the device are contemplated including, but not limited to, any combination of the various elements of the device and their variations as described herein. Accordingly, the invention is intended to encompass the full scope of the appended claims.

Two variations of an alternative embodiment 300 are shown in FIGS. 7 and 8. The device comprises a single primary loop 350 of woven strap 340 that is joined via a buckle 315, snaps, hook and loop material 345, or some other connecting means, including but not limited to sewn thread and adhesive. The loop 350 of the alternative device is passed through the slotted openings of a car seat in such a manner at to effectively form two secondary loops 305 on either side of the slotted openings for passing an arm of the user therethrough. The secondary loops can include padded sections 335 to increase the user's comfort when carrying a car seat. By adjusting the length of the primary loop via the buckle 315, hook and loop material 345, or other adjustable connecting means the size of the secondary loops can be effectively varied to adjust the device for users of various sizes. The sections of the strap 340 forming the center section equivalent 310 of the alternative embodiment device may or may not be joined together through snaps, clips, or hook and loop material.

Another alternative embodiment can comprise separate shoulder straps that connect to the car seat in any suitable location. For instance, a car seat could be designed with features, such as snaps, or specifically located slots that permit the straps to be directly connected to car seat without the straps being joined together by a center section. In another alternative embodiment, the straps can be replaced with rigid padded shoulder hooks that firmly attach to the back or side of the car seat and are brought into contact with the user's shoulder to bear the weight of the car seat thereon.

I claim:

1. A device for a user to carry a car seat on his/her back while walking without requiring the use of his/her hands, the device comprising:
A first shoulder support;
A second shoulder support; and
A center section spanning between and connected to the first and second shoulder supports, the center section being adapted to connect with the car seat.

2. The device of claim 5, wherein the first and the second shoulder supports comprise first and second strap loops.

3. The device of claim 6, wherein the first and the second strap loops comprise a woven material.

4. The device of claim 7 wherein the sizes of the first and the second strap loops are adjustable by the user.

5. The device of claim 6, wherein at least a portion of the first and the second strap loops are padded.

6. The device of claim 5, wherein the center section comprises a generally flexible strap.

7. The device of claim 2, wherein the first shoulder strap loop, the second shoulder strap loop and the center section together comprise a single looped strap.

8. The device of claim 2, further comprising a strap length adjustment mechanism for varying the size of the first and the second shoulder strap loops.

9. The device of claim 8, wherein the strap length adjustment mechanism comprises a buckle.

10. The device of claim 1, wherein the center section comprises a strap.

11. The device of claim 10, wherein the center section strap is sized to fit through one or more slotted openings in the car seat.

12. The device of claim 10, wherein the center section strap is comprised of a woven material.

13. The device of claim 8, wherein the strap length adjustment mechanism comprises hook and loop material.

14. A method of transporting an infant or child car seat by a user, the method comprising:
attaching a car seat carrying device to the car seat, the device comprising first and second shoulder supports and being adapted to permit the user to carry the car seat with the car seat being in general contact with his/her back and wherein a substantial portion of the weight of the car seat is transferred through the shoulder supports to the user's body;
placing a first shoulder support on a first shoulder of the user;
placing a second shoulder support on a second shoulder of the user;
situating the car seat in general contact with a back of the user; and
walking with the car seat in general contact with the back.

15. The method of claim 1, wherein the first shoulder support comprises a looped strap and said placing a first shoulder support on a first shoulder of the user further comprises placing a first arm of the user through the looped strap.

16. The method of claim 1, further comprising:
removing the car seat from a vehicle.

17. The method of claim 1, wherein said walking with the car seat further includes walking between an automobile and an airport building.

18. A system comprising:
An car seat for one of an infant and a child;
a device for carrying the car seat, the device including first and second shoulder strap loops, and a center section connected with the first and the second shoulder strap loops, the center section being connected to the car seat;wherein a user places the first and the second shoulder strap loops on his/her respective left and right shoulders with the car seat in general contact with his/her back.

19. The system of claim 18, wherein the center section comprises a strap extends through one or more openings provided in the car seat, the one or more slotted openings being adapted to receive at least one of a seat belt or a LATCH strap therethrough when the seat is secured in a vehicle.

20. The system of claim 19, wherein left and right ends of the center section are sewn to the first and second shoulder strap loops respectively.
